(19) United States
(12) Patent Application Publication
(10) Pub. No.: US 2008/0201126 A1
(43) Pub. Date: Aug. 21, 2008

(54) Method of Automatically Generating the Structures From Mask Layout

(75) Inventors: Tae Young Won, Kyeonggi-do (KR); Sang Ho Yoon, Incheon (KR)

Correspondence Address: MARTINE PENILLA & GENCARELLA, LLP, 710 LAKEWAY DRIVE, SUITE 200, SUNNYVALE, CA, 94085, US

(73) Assignee: SANAYI SYSTEM CO., LTD., Nam-gu, Incheon (KR)

(21) Appl. No.: 10/552,132

(22) PCT Filed: May 19, 2004
(86) PCT No.: PCT/KR2004/001183

§ 371 Date: Mar. 19, 2008

(30) Foreign Application Priority Data
Feb. 5, 2004 (KR) 10-2004-0007435

(51) Int. Cl. G06F 17/50

(52) U.S. Cl. 703/14

(57) ABSTRACT

A method of defining three-dimensional structure from mask layout for computer simulation, which provides a technology for defining a three-dimensional structure of liquid crystal cell which comprises a apparatus of liquid crystal display for designing and analyzing a apparatus of liquid crystal display.

A method of generating three-dimensional structure which comprised of material layers between upper substrate and lower substrate, which provides a generation method of three-dimensional structure for computer simulation by depositing material layers under the upper substrate and over the lower substrate, and sandwiching a center insertion layer between the deposited upper and lower material layers for a case which includes tapered structure of material layer for the substrate.

### FIELD OF THE INVENTION

The present invention relates to a method for generating a three-dimensional structure of a liquid crystal cell, which can be employed for designing the LCD panel by predicting the dynamics of a liquid crystal pixel, and a computer software system utilizing the same.

More particularly, the present invention relates to a method for estimating a three-dimensional structure comprising a plurality of material layers between upper and lower substrates through computer simulation from the a mask layout input data, wherein the three-dimensional structure is defined through the computer simulation by depositing the material layers on the upper and lower substrates acting as reference base planes, respectively, and sandwiching an intermediate insertion layer between the upper and lower substrates with the material layers thereon facing each other, in particular, in the case where at least one of the material layers has a tapered region (which will be referred to as an “tapered material layer”), which is not parallel to the upper and lower substrates and is inclined to the base planes.

A liquid crystal display is a display apparatus generally constructed such that a liquid crystal material is filled in a space between a lower substrate having a thin film transistor, a pixel electrode and the like formed thereon and an upper substrate having an opposite electrode, a color filter, and the like formed thereon.

For the computer simulation of the liquid crystal display, a conventional software system for two-dimensional computer simulation employs a method of defining polygons as cross-sectional shapes of the liquid crystal cell in order to define a three-dimensional structure of the liquid crystal cell, and thus it is difficult for the conventional software system to define the three-dimensional structure of the liquid crystal cell.

### SUMMARY OF THE INVENTION

Accordingly, it is an object of the present invention to provide a method for producing a three-dimensional structure from a mask layout.

It is another object of the present invention to provide a method for defining a three-dimensional structure of a liquid crystal cell constituting a liquid crystal display.

It is yet another object of the present invention to provide a system for defining the three dimensional structure of the liquid crystal cell constituting the liquid crystal display.

In accordance with one aspect of the present invention, the above and other objects can be accomplished by the provision of a method for defining a three-dimensional structure of a liquid crystal cell, comprising the steps of: reading mask layout information for the liquid crystal cell; inputting a deposition sequence of material layers constituting the liquid crystal cell by use of the mask layout information for the liquid crystal cell; and defining the three-dimensional structure of the liquid crystal cell by use of the mask layout information in which a mask layout consists of polygons.

In accordance with another aspect of the present invention, a system for defining a three-dimensional structure of a liquid crystal cell is provided, comprising: a preparation module for mask layout information; an input module for a deposition sequence of material layers constituting the liquid crystal cell; a change module for polygons constituting the mask layout; and a creation module for a three-dimensional structure of the liquid crystal cell.

### BRIEF DESCRIPTION OF THE DRAWINGS

Further features of the present invention will become apparent from a description of a method for defining a three-dimensional structure of a liquid crystal cell, which can be applied to manufacturing a computer simulation analyzer for predicting dynamic kinetics of a liquid crystal display, and a computer software system utilizing the same taken in conjunction with the accompanying drawings of the preferred embodiment of the invention, which, however, should not be taken to be limitative to the invention and are for explanation and understanding only.

In the drawing:

FIG. 1 is a flow diagram illustrating a method for defining a three-dimensional structure of a liquid crystal cell in accordance with a preferred embodiment of the present invention.

FIG. 2 is a flow diagram illustrating a preferred embodiment of a process for inputting a deposition sequence of material layers constituting the liquid crystal cell by use of mask layout information for the liquid crystal cell in the method of the invention.

FIGS. 3 to 7 show sequential steps of the method for defining the three-dimensional structure of the liquid crystal cell in accordance with the embodiment of the invention.

FIG. 8 is a constitutional view of a system for defining a three-dimensional structure of a liquid crystal cell in accordance with a preferred embodiment of the invention.

FIG. 9 is a view illustrating a preferred embodiment of a preparation module for mask layout information.

FIG. 10 is a view illustrating a preferred embodiment of an input module for a deposition sequence of material layers constituting the liquid crystal cell, which is exhibited when selecting a button for defining the three-dimensional structure.

FIG. 11 is a view illustrating a preferred embodiment of an input module for the information of material layers, which is exhibited when selecting a button for adding a new material layer.

### DETAILED DESCRIPTION OF THE PREFERRED EMBODIMENT OF THE INVENTION

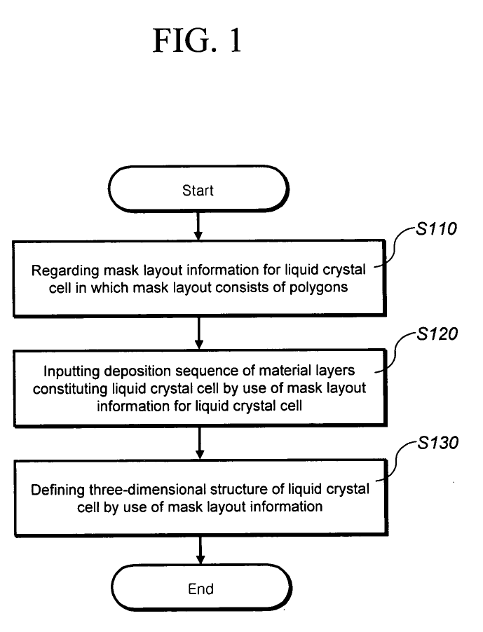

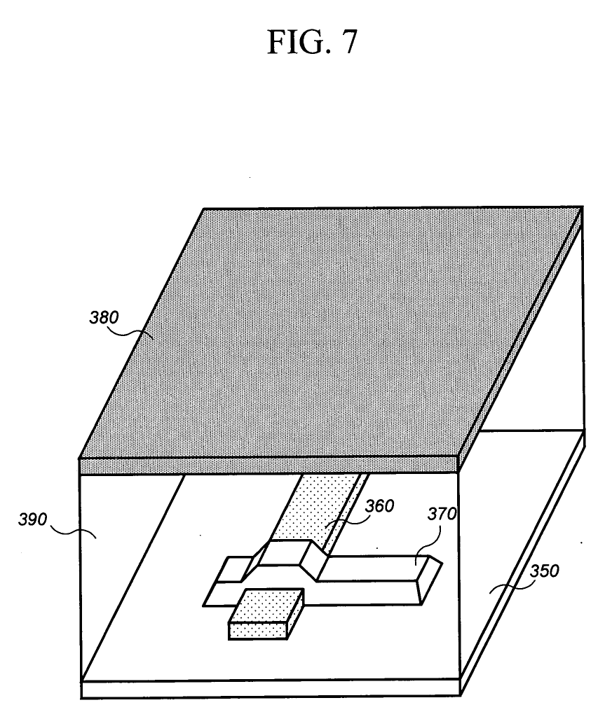

Embodiments of the present invention will now be described in detail with reference to FIGS. 1 and 7.

FIG. 1 is a flow diagram illustrating a method for defining a three-dimensional structure of a liquid crystal cell according to the invention. Referring to FIG. 1, the method comprises the steps of reading mask layout information for the liquid crystal cell in which a mask layout consists of polygons (S110); inputting a deposition sequence of material layers constituting the liquid crystal cell by use of the mask layout information for the liquid crystal cell (S120); and defining the three-dimensional structure of the liquid crystal cell by use of the mask layout information (S130).

According to the preferred embodiment of the invention, the mask layout information for the liquid crystal cell structure is provided in the form of an electronic file produced by a mask layout producing system.

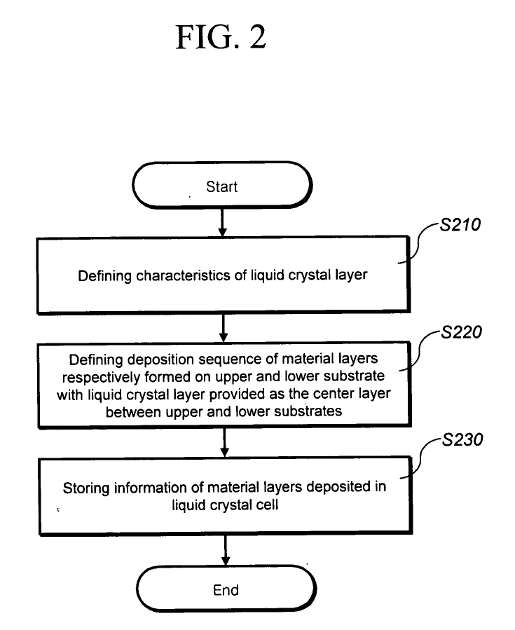

FIG. 2 is a flow diagram illustrating a preferred embodiment of a process for inputting a deposition sequence of material layers constituting the liquid crystal cell by use of the mask layout information for the liquid crystal cell structure in the method of the invention. Referring to FIG. 2, the process comprises the steps of defining characteristics of a liquid crystal layer (S210); defining the deposition sequence of the material layers respectively formed on upper and lower substrate with the liquid crystal layer provided as a center layer between the upper and lower substrates (S220); and storing information of the material layers deposited in the liquid crystal cell (S230).

According to the preferred embodiment of the invention, the characteristics of the liquid crystal layer may be determined by a method of defining a kind of liquid crystal material and a thickness of the liquid crystal layer with regard to the basically produced liquid crystal layer.

According to the preferred embodiment of the invention, the step of defining the deposition sequence of the material layers on the upper and lower substrates with the liquid crystal layer provided as the center layer between the upper and lower substrate may be realized by a process of sequentially defining the material layers constituting the upper and lower substrates from the lower substrate to the upper substrate in the vertical direction with the liquid crystal layer basically produced as the center layer between the upper and lower substrates, and alternatively, by a process of defining a new material layer, which is inserted between the previously defined material layers. The new material layer may be defined using a name of the material layer, a kind of the material, a thickness of the material layer, a name of the mask, a kind of positive or negative mask, an angle of side surface, and a kind of the substrate.

According to the preferred embodiment of the invention, the information of the deposited material layer in the liquid crystal cell may be directly stored in a memory of a computer. Alternatively, the information of the deposited material layer may be provided as an electronic file in a storing media, such as a hard disk drive, for the computer.

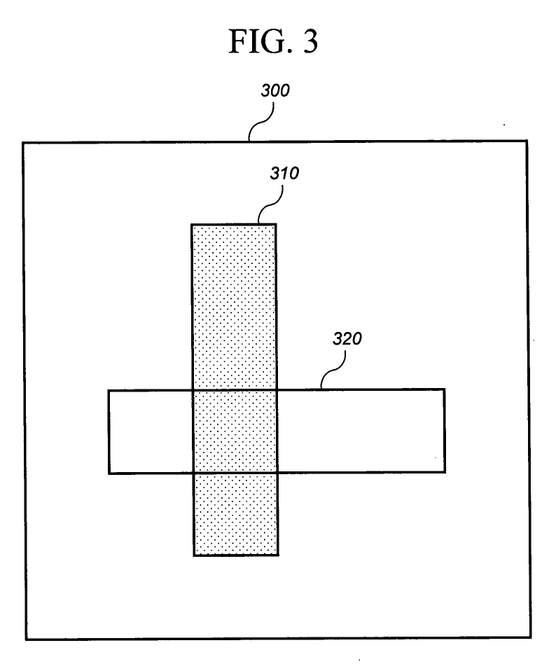

FIGS. 3 to 6 show a preferred embodiment of a method for defining the three-dimensional structure of the liquid crystal cell of the invention. Referring to FIG. 3, as the preferred embodiment of the mask layout information for defining the three-dimensional structure, the information of the mask layout consisting of a region 300 for defining the three-dimensional structure, a first mask 310 and a second mask 320 is shown.

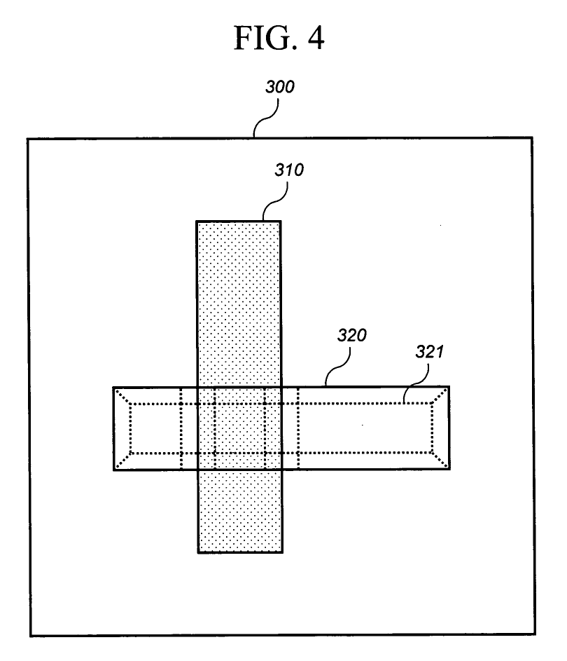

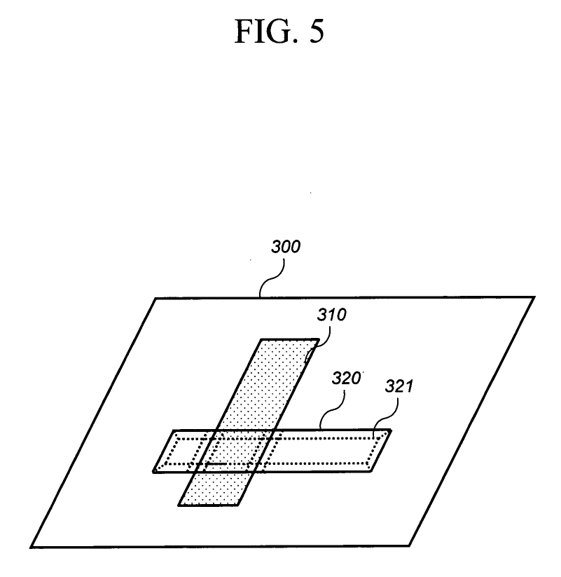

Referring to FIG. 4, the first mask 310 is a mask to which a taper angle is not designated, and the second mask 320 is a mask to which the taper angle is designated. With the second mask 320 to which the taper angle is designated, a divided polygon 321 is formed by dividing an internal area of a polygon of a mask layout object along edges overlapped by the polygon of the mask layout object and a polygon of another mask. FIG. 5 shows the three-dimensional structure of the mask of FIG. 4.

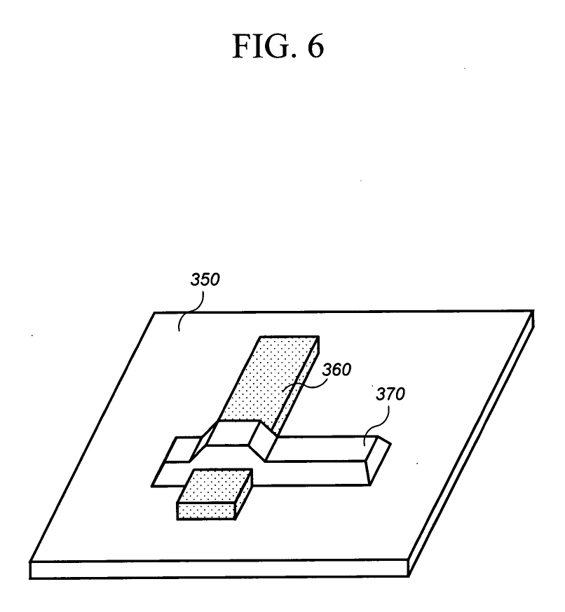

Referring to FIG. 6, a first material layer 350 having a predetermined thickness is formed by use of the region 300 for defining the three-dimensional structure, a second material layer 360 having a predetermined thickness is formed on the first material layer 350 by use of the first mask 310, and a third material layer 370 is formed on the three-dimensional structure consisting of the first material layer 350 and the second material layer 360 by use of the second mask 320 having the divided polygon 321.

According to the preferred embodiment of the invention, a thickness of each material layer may be designated by a user. According to the preferred embodiment, the second material layer 360 may be formed by expanding the structure of the first mask 310 upward by a thickness designated by the user from an upper surface of the first material layer 310.

According to the preferred embodiment of the invention, in order to form the third material layer 370, the structure of the second mask 320 is initially formed as a lower surface of the third material layer 370 on an exposed upper surface of the three-dimensional structure consisting of the first and second material layers 350 and 360, an upper surface of the third material layer 370 is produced by expanding the structure of the divided polygon 321 upward by a thickness designated by the user from the lower surface of the third material layer 370, and side surfaces of the third material layer 370 are then formed by connecting apexes of the lower surface of the third material layer 370 to corresponding apexes of the upper surface of the third material layer 370.

Referring to FIG. 7, in addition to the three-dimensional structure of the lower substrate consisting of the first, second and third material layers 350, 360 and 370, a fourth material layer 380 constituting the upper substrate is formed at a position displaced a thickness of the liquid crystal material designated by the user from the lowest point of the upper surface of the lower substrate in the vertical direction, and a fifth material layer 390 is formed between the lower surface of the upper substrate and the upper surface of the lower substrate. According to the preferred embodiment of the invention, the fifth material 390 filling a space between the lower substrate and the upper substrate is defined as the liquid crystal material.

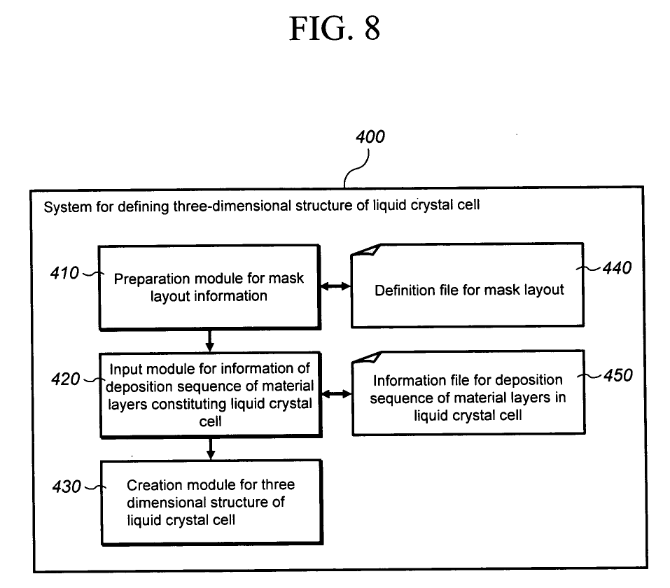

FIG. 8 is a constructional view of a system for defining the three-dimensional structure of the liquid crystal cell of the liquid crystal display according to the invention. Referring to FIG. 8, the system 400 for defining the three-dimensional structure of the liquid crystal cell comprises a preparation module 410 for mask layout information, an input module 420 for information of a deposition sequence of material layers constituting the liquid crystal cell, a creation module 430 for the three dimensional structure of the liquid crystal cell, a definition file 440 for the mask layout, and an information file 450 for the deposition sequence of material layers in the liquid crystal cell.

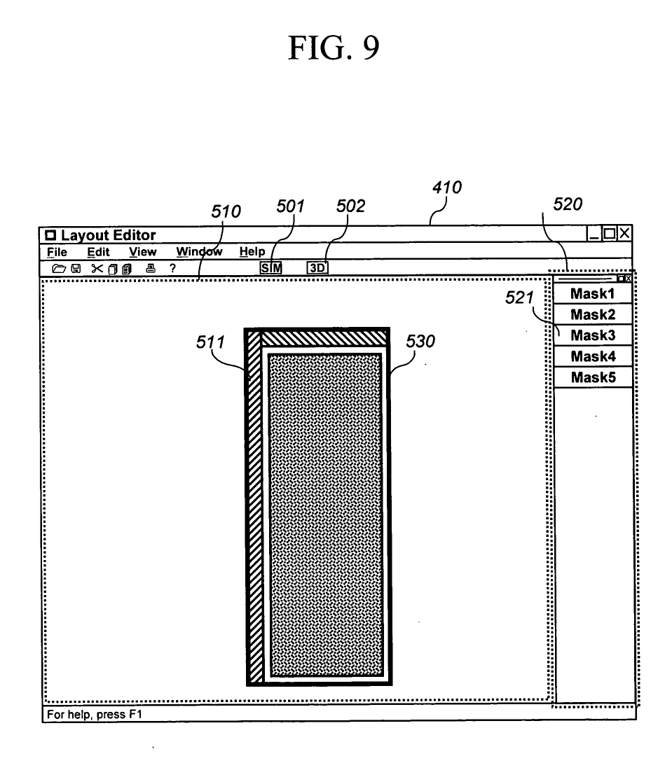

FIG. 9 is a view of a preferred embodiment of the preparation module 410 for the mask layout information. Referring to FIG. 9, the preparation module 410 comprises a simulation region setting button 501, a three-dimensional structure defining button 502, a mask layout preparation portion 510, and a mask management portion 520. The mask management portion 520 has a function for selecting a mask 521 from a mask list while exhibiting the mask list included in the definition file 440 for the mask layout, and the simulation region setting button 501 has a function for drawing a mask object 511 on the mask selected from the mask list 520. The simulation region setting button 501 has a function for setting the simulation region 530 in the mask layout producing portion 510. The mask management portion 520 has a function for allowing the input module 420 for the information of deposition sequence of material layers constituting the liquid crystal cell to be executed.

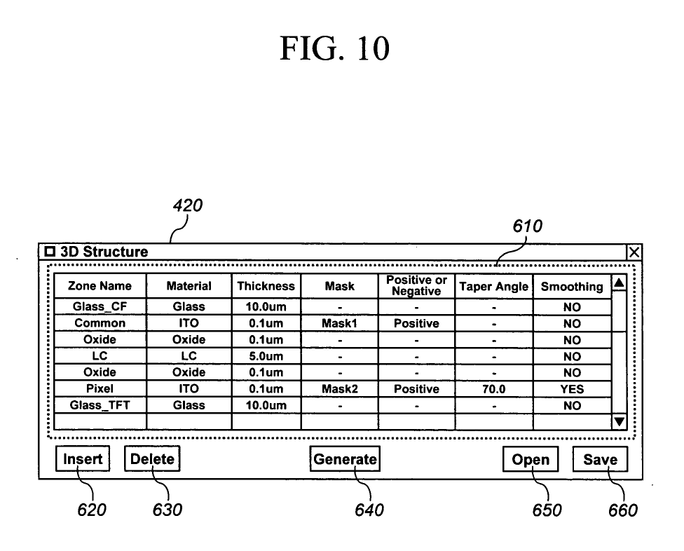

FIG. 10 is a view illustrating a preferred embodiment of the input module 420 for the information of the deposition sequence of material layers constituting the liquid crystal cell, which is exhibited when selecting the three-dimensional structure defining button 502. Referring to FIG. 10, the input module 420 for the information of deposition sequence of material layers constituting the liquid crystal cell comprises an information viewer 610 for the deposition sequence of the material layers, an insert button 620 for adding a new material layer, a delete button 630 for deleting the new material layer selected from the information viewer 610 for material layers, an execution button 640 for generating the three-dimensional structure, an opening button 650 for reading the information of material layers, and a save button 660 for saving the information of material layers.

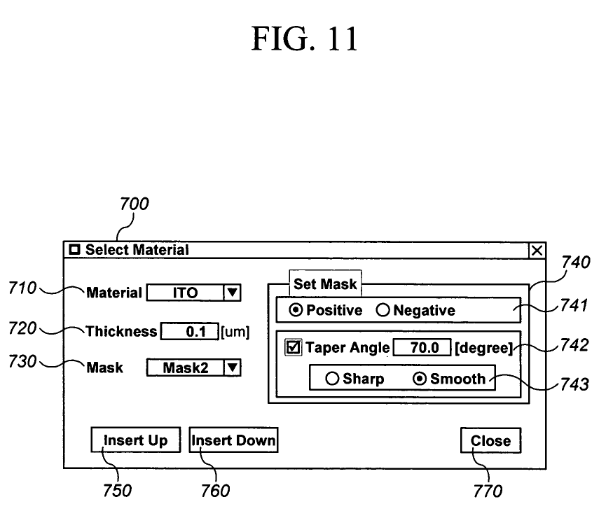

FIG. 11 is a view illustrating a preferred embodiment of an input module 700 for the information of material layers, which is exhibited when selecting the insert button 620 for adding the new material layer. Referring to FIG. 11, the input module 700 for the information of material layers comprises a material selecting portion 710, an input portion 720 for a thickness of the material layer, a mask selecting portion 730, a mask characteristic setting portion 740, an upward-insert button 750 for adding a new material layer above the selected material layer, a downward-insert button 760 for adding a new material layer under the selected material layer, and a close button 770 for closing the input module 700 for the information of material layers.

The mask characteristic setting portion 740 comprises a mask selecting portion 741 between a positive mask and a negative mask, a taper angle input portion 742 for inputting a taper angle at edges of the material layer when depositing the material layers using the mask, and a selection portion 743 for selecting whether a side surface of the material layer using the mask is formed with a sharp taper angle or a smooth taper angle.

As apparent from the above description, the invention provides the system for defining the three-dimensional structure of the liquid crystal cell of the liquid crystal display, which comprises the preparation module for the mask layout information, the input module for the deposition sequence of material layers in the liquid crystal cell, and the definition module for defining the three-dimensional structure of the liquid crystal cell, and the method for defining the three-dimensional structure of the liquid crystal cell, which comprises the step of inputting the deposition sequence of material layers of the liquid crystal cell using the mask layout information for the liquid crystal cell and the step for defining the three-dimensional structure of the liquid crystal cell using the information of the mask layout consisting of the polygons, thereby constituting the structure definition system for executing computer simulation for the liquid crystal cell of the liquid crystal display.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments within a scope encompassed and equivalents thereof with respect to the features set forth in the appended claims.

What is claimed is:

1. A method for defining a three-dimensional structure comprising a plurality of material layers between upper and lower substrates through computer simulation using input data of mask layout, wherein the three-dimensional structure is defined during the computer simulation by depositing material layers on the upper and lower substrates acting as reference base planes, respectively, and sandwiching an intermediate insertion layer between the upper and lower substrates with the material layers thereon facing each other, in particular, when at least one of the material layers has a tapered region (which will be referred to as an “tapered material layer”), which is not parallel to the upper and lower substrates and is inclined to the base planes.

2. The method as set forth in claim 1, comprising the steps of:
a) designating a certain material layer as the intermediate insertion layer among the plurality of material layers formed between the upper and lower substrates, followed by designating parameters including a thickness of the intermediate insertion layer and/or a kind of material thereof;
b) designating information of a name, a kind of material, a thickness, and an associated mask for each of the plurality of material layers deposited onto the upper substrate and the lower substrate formed at upper and lower surfaces of the three-dimensional structure with the intermediate insertion layer formed at the center between the upper and lower substrates, and information of a taper angle of the tapered material layer when the at least one of the material layers has the tapered region, which is not parallel to the upper and lower substrates and is inclined to the base planes, followed by defining a deposition sequence for the material layers on the upper and lower substrates, respectively; and
c) determining whether each of the material layers is formed by use of polygons defining a mask layout object defined for the associated mask as a lower surface of the material layer or by use of remaining regions as the lower surface of the material layer except for the polygons defining the mask layout object defined for the associated mask.

3. The method as set forth in claim 1, comprising the steps of:
a) forming an internal polygon within a polygon defining a mask layout object for a mask having a designated taper angle, the internal polygon having a size smaller than the polygon defining the mask layout object while having the same shape and sequence of apexes as those of the polygon defining the mask layout object, followed by forming side polygons dividing a planar space between the internal polygon and the polygon defining the mask layout object by connecting the apexes of the internal polygon to the associated apexes of the polygon defining the mask layout object such that the apexes having the same sequences are connected to each other from the internal polygon to the polygon defining the mask layout object;
b) forming lines at both sides of edges of each of polygons defining a mask layout object defined for another mask except for the mask having the designated taper angle so as to be parallel to both sides of the edges of each of the polygons at an overlap region between the polygons defining the mask layout object defined for the other mask except for the mask having the designated taper angle and the polygon defined for the mask having the designated taper angle, followed by dividing the polygon defined for the mask having the designated taper angle by use of the lines;
c) when forming the material layer using a mask without the designated taper angle or the material layer formed without a designated mask according to information of a deposition sequence for the material layers on the lower substrate, depositing a material for the material layer using the mask without the designated taper angle to have a thickness designated by a user upward from an upper surface of the material layer previously defined on the lower substrate
d) when forming the material layer using the mask having the designated taper angle according to the information of the deposition sequence of the material layers on the lower substrate, defining the mask layout object as a lower surface of the material layer using the mask having the designated taper angle over the upper surface of the material layer previously defined on the lower substrate, the internal polygon of the mask layout object as an upper surface of the material layer using the mask having the designated taper angle at a position spaced a predetermined thickness upward from the upper surface of the material layer previously defined on the lower substrate, and the side polygons of the mask layout object as side surfaces of the material layer using the mask having the designated taper angle, respectively, followed by depositing a new material for the material layer formed using the mask having the designated taper angle in a region surrounded by the polygon of the lower surface, the polygon of the upper surface, and the polygons of the side surfaces;
e) when forming the material layer using the mask without the designated taper angle or the material layer formed without using the designated mask according to the information of the deposition sequence of the material layers on the upper substrate, depositing another new material for the material layer formed using the mask without the designated taper angle or the material layer formed without using the designated mask to have a predetermined thickness downward from a lower surface of the material layer previously defined on the upper substrate;
f) when forming the material layer using the mask having the designated taper angle according to information of a deposition sequence of the material layers on the upper substrate, defining the mask layout object as an upper surface of the material layer using the mask having the designated taper angle over the lower surface of the material layer previously defined on the upper substrate, the internal polygon of the mask layout object as a lower surface of the material layer using the mask having the designated taper angle at a position spaced a predetermined thickness downward from the lower surface of the material layer previously defined on the upper substrate, and the side polygons of the mask layout object as side surfaces of the material layer using the mask having the designated taper angle, respectively, followed by depositing another new material for the material layer formed using the mask having the designated taper angle in a region surrounded by the polygon of the upper surface, the polygon of the lower surface, and the side surfaces;
g) when forming the material layer using the mask having the designated taper angle according to the information of the deposition sequence of the material layers on the upper substrate, depositing another new material for the material layer downwardly, the material layer using the mask layout object as an upper surface of the material layer using the mask having the designated taper angle on the lower surface of the material layer previously defined on the upper substrate, the internal polygon of the mask layout object as a lower surface of the material layer using the mask having the designated taper angle at a position spaced the predetermined thickness downward from the lower surface of the material layer previously defined on the upper substrate, and the side polygons of the mask layout object as side surfaces of the material layer using the mask having the designated taper angle;
h) displacing the upper substrate upward such that the highest apex among the apexes of the polygons constituting the upper surface of the defined lower substrate is located at a position spaced a thickness of the crystal liquid region designated by the user from the lowest apex among the apexes of the polygons constituting the upper surface of the defined lower substrate; and
i) filling a space between the upper substrate and the lower substrate with the intermediate insertion layer.
